(19) United States
(12) Patent Application Publication
(10) Pub. No.: US 2010/0061923 A1
(43) Pub. Date: Mar. 11, 2010

(54) HYDROGEN PRODUCTION AND USE

(76) Inventor: Alla V.K. Reddy, Plainsboro, NJ (US)

Correspondence Address: DICKSTEIN SHAPIRO LLP, 1633 Broadway, NEW YORK, NY, 10019, US

(21) Appl. No.: 12/499,299

(22) Filed: Jul. 8, 2009

Related U.S. Application Data
(60) Provisional application No. 61/196,239, filed on Oct. 16, 2008.
(60) Provisional application No. 61/206,199, filed on Jan. 27, 2009.
(60) Provisional application No. 61/209,773, filed on Mar. 11, 2009.
(60) Provisional application No. 61/191,173, filed on Sep. 5, 2008.

(51) Int. Cl. C01F 7/06; B01J 19/00; B01J 3/00

(52) U.S. Cl. 423/600; 422/129; 422/242

(57) ABSTRACT

Sodium is reacted with water to form hydrogen, sodium hydroxide and heat, and the sodium hydroxide is reacted with aluminum to produce hydrogen and sodium aluminate, while the violent nature of the reactions is modulated by employing the exothermic heat of the reactions to convert solid sodium to liquid sodium and to convert liquid water to steam. The pressurized hydrogen generated is used to drive one or more power generators which utilize pressure to generate power. The reactions take place in a reaction chamber in which a water reservoir is disposed in open communication with a main reaction chamber.

### CROSS-REFERENCE TO RELATED APPLICATIONS

This application claims the benefit of U.S. Provisional Application Nos. 61/196,239, filed Oct. 16. 2008, 61/191,173, filed Sep. 5, 2008, 61/206,199, filed Jan. 27, 2009, and 61/209,773 filed Mar. 11, 2009, the entire contents of each being incorporated herein by reference.

### BACKGROUND OF THE INVENTION

There is a continuing effort to provide alternative fuels from the point of view of reducing dependence on fossil fuels and to reduce or eliminate the pollution which results from the burning of such fuels. The scientific literature is replete with a myriad of approaches to this goal, including attempts to harness solar, wind and even tidal wave energy.

It is generally agreed that elemental hydrogen is potentially a very abundant fuel and potentially very non-polluting because water is the product of its combustion. Nevertheless, hydrogen continues to be underutilized as a fuel in light of the problems encountered in achieving a safe, efficient, and economical method of producing it in sufficient quantities for practical use. Moreover, at atmospheric pressure, hydrogen contains about one-fourth the energy contained in an equal volume of gasoline.

Among the many methods of making hydrogen gas are the elementary electrolysis of water, coal gasification, steam reforming of natural gas, partial oxidation of heavy oils and the use of nuclear reactors to break down steam into its component elements. All of these generally require incurring the cost of extensive capital equipment, large production capabilities, and require an input of significant external energy.

The reaction of alkali metals such as sodium with water to form hydrogen and the alkali metal hydroxide is well known, as is the fact that the reaction is rapid and violent, the heat generated is intense, and there is a danger of explosion. The reaction of alkali hydroxides, such as sodium hydroxide, with a metal such as aluminum to produce hydrogen and form the alkali metal hydroxide is also well known. That reaction can also be rapid and violent. There have been numerous attempts to take advantage of these reactions but slow them down to counteract their violent nature by combining the metals in various ways, such as by forming alloys, amalgams, and combination with various inert materials. See, e.g., U.S. Pat. Nos. 909,536, 3,985,866, 4,308,248, 6,834,623, and 6,969,417.

### SUMMARY OF THE INVENTION

A new method has been found which takes advantage of the known reactions of sodium and water, and of aluminum and sodium hydroxide to produce an abundant supply of hydrogen, and steam, in a simple way, while exercising more control over the violent nature of the reactions, and at the same time avoiding the production of byproducts which pollute the atmosphere. The method can be designed to produce pressurized hydrogen and/or steam which can then be used as a working fluid, e.g., to operate turbines, cylinders, or to make hydrogen available as a fuel, e.g., in a fuel cell or the like. A side benefit of the method is the production of sodium aluminate, which is in short supply.

In the present invention, sodium is reacted with water to form hydrogen, sodium hydroxide and heat, and the sodium hydroxide is reacted with aluminum to produce hydrogen and sodium aluminate, with heat, while the violent nature of the reactions is modulated by employing the exothermic heat of the reactions to convert solid sodium to liquid sodium and to convert the water to steam. The volume of the steam and hydrogen is preferably employed to control the chemical reactions involved. The pressurized gases produced can be used to generate energy, similarly to the generation of electricity using 450° C. steam pressurized to 90 Kg/cm². In one embodiment, the mixture of hydrogen and steam is released to the atmosphere under high pressure and then hydrogen part of the mixture is ignited while it is entering into atmosphere to generate jet pressure.

The reactions are effected in a reaction chamber and the safety of the system can, if desired, be increased by employing the hydrogen gas produced to expel any oxygen from the chamber. In one embodiment of the present invention, the chemical reactions takes place with the addition of water directly onto the chemicals in the reactor which is composed of a pair of tanks, one inside the other, with a water inlet into the chamber between the first and second tanks. When the temperature of the reactor elevates to about 200-400° C., the water entering the space between the first and second tanks is converted into steam which can be utilized for additional power generation. Most of the time, the hydrogen present in the upper part of the reactor will not allow the steam generated in the chamber between the tanks to communicate with the chemicals.

The invention also concerns a reaction chamber in which a water reservoir is disposed in open communication with the main chamber where the reactions take place.

These and other features of the invention will become apparent to those of ordinary skill in this art from the following detailed description in conjunction with the drawings hereof.

### BRIEF DESCRIPTION OF THE DRAWINGS

FIG. 1 is a schematic drawing of a reaction chamber according to the invention.

FIG. 2 is a schematic drawing of another reaction chamber according to the invention coupled to a turbine.

FIG. 3 is a schematic drawing of another reaction chamber according to the invention coupled to a series of turbines.

FIG. 4 is a schematic drawing of yet another reaction chamber according to the invention.

FIG. 5 is a schematic drawing of a further reaction chamber according to the invention coupled to a cylinder through an optional pressure balancing chamber.

FIG. 6 is a schematic of an alternative reaction chamber according to the invention.

FIG. 7 is a schematic of a yet another alternative reaction chamber according to the invention.

### DETAILED DESCRIPTION OF THE INVENTION

In accordance with the present invention, sodium is reacted with water to form hydrogen, sodium hydroxide and heat, and the resultant sodium hydroxide is reacted with aluminum to produce hydrogen and sodium aluminate. Initially, both the sodium and aluminum are employed in the form of solids, the size of which can vary depending on the size of the reactor. For a relatively small reactor, preferably used are small particles generally having a largest dimension of about 10 to 20 mm. The larger the reactor, the larger the size of the solids can be. The shape of the particles is not restricted and they can be regular or irregular, round, oblong, etc.

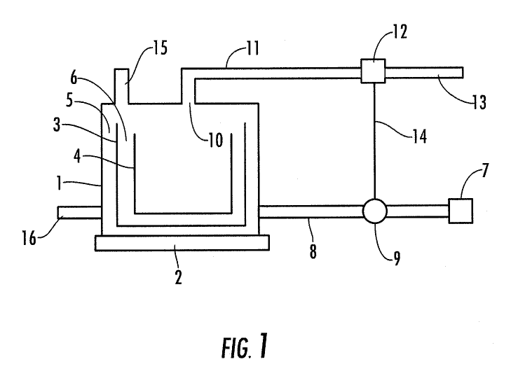

FIG. 1 is a schematic drawing of one possible reaction chamber which can be used in the present invention. Any material which is sufficiently strong to withstand the pressures built up during the reactions can be used to construct the reaction chamber 1. It has been found that, for instance, Alloy 400 (an alloy of nickel, copper and iron) and Alloy 600 (an alloy of nickel, iron and chromium) is sufficient provided that the chamber walls have sufficient thickness. Mild steel (mp 1400° C.) could also be used.

Reaction chamber 1 is mounted on a base 2 and contains an inner tank 3 within which is disposed a main chamber 4 with spaces between them. A first space 5 is between the reaction chamber 1 and inner tank 3 and a second space 6 is between inner tank 3 and main chamber 4. Spaces 5 and 6 are in open communication with main chamber 4. The height of inner tank 3 is greater than that of main chamber 4, so that contents in space 5 can overflow into space 6. Similarly, the contents of space 6 can overflow into main chamber 4.

Sodium and aluminum are disposed in main chamber 4. They may be combined. There is no restriction on relative amounts of these elements but since each mole of sodium generates one mole of sodium hydroxide, and one mole of the hydroxide forms one mole of aluminate, approximate equal molar amounts of the sodium and aluminum are preferred.

Water from a supply 7 is conveyed through a conduit 8 by means of a dosing pump 9 into space 5. In other embodiments, the water can be introduced directly into main chamber 4 through an additional inlet or by repositioning conduit 8 to lead directly into main chamber 4. When space 5 is filled, the water overflows into space 6 and when space 6 is filled, the water overflows into main chamber 4 where it comes into contact with the sodium and aluminum. The water reacts with the sodium to form hydrogen, sodium hydroxide and heat and the sodium hydroxide produced reacts with the aluminum to form sodium aluminate and additional hydrogen. The water introduction rate is the rate controlling parameter of the entire process.

The sodium-water reaction is very exothermic and the high temperature generated converts the water within reactor 1 into a superheated steam and also converts the solid sodium in main chamber 2 into liquid sodium. The liquid sodium helps to control the system by absorbing heat in a manner which is similar to its use as a coolant in fast breeder nuclear reactors.

A mixture of steam and hydrogen exits reactor 1 through outlet 10 into conduit 11 which contains a flow meter 12 and shut off valve 13.

Flow meter 12 senses the volume of gas flowing through conduit 11 and in response, adjusts dosing pump 9 via a communication line 14. When the volume of the mixture sensed by meter 12 is too low, it causes pump 9 to introduce more water into the system and hence increase the amount of reaction taking place in main chamber 2. Conversely, when the volume sensed is too high, it causes pump 9 to slow down or stop conveying water into reaction chamber 4

It has been found that controlling the chemical reactions taking place in main chamber 4 by regulating water introduction based on the volume of the steam and hydrogen gases is better than controlling the reaction based on either pressure or temperature. The reason is that there is more precise control over the reaction system when the flow meter action is based on the volume of the steam and hydrogen in the exit gases. Relying on pressure requires a time factor adjustment because the water in the steam phase will continue to react with the sodium even after the water introduction into the reaction chamber ceases, and the pressure in the chamber will continue to rise, possibly putting an undue burden on the reactor materials of construction. Also, the sodium in liquid form may present a greater surface area than solid sodium pieces and therefore more sodium can react with the water in the vapor. Likewise, the reaction temperature will continue to rise even after the water introduction has ended because the exothermic reaction continues for the same reasons. Relying on flow volume does not have the same degree of dependence on a time dependency parameter.

Hydrogen and oxygen can be an explosive mixture. One way to increase safety is to expel any oxygen containing material, particularly air, from main reaction chamber 4 and replace it with an inert gas before initiating the sodium/water reaction. However, that also means that the hydrogen product exiting the reaction chamber will contain entrained inert gas. A preferred alternative is to provide an air outlet 15 so that the hydrogen and/or steam generated can force the air out of the chamber. Once all air is expelled, outlet 15 can be closed. However, no explosive consequences have been encountered as long as either outlet 15 was open or all air was expelled from reaction chamber 1.

If desired, any excess heat that is not being employed within a main reaction chamber 4 can be used as a heat source for heat exchange outside reaction chamber 1. This permits the excess heat energy can be employed for other uses. It has been done in the past, as taught in U.S. Pat. No. 3,975,913.

The reactions taking place in main chamber 2 generate large amounts of hydrogen gas and steam, as well as sodium aluminate. The aluminate can be withdrawn from main chamber 4 through an outlet 16, which is preferably disposed in a lower region of main chamber 4. Since it is desired to employ the pressure generated by the hydrogen and steam gases as a working fluid, flow meter 12 and cutoff valve 13 are used to establish a desired pressure. When shutoff valve 13 is closed, the continuous generation of hydrogen and steam in main chamber 4 causes those gases to be compressed under pressure. When the pressure of the compressed gas is appropriate for the end use under consideration, it is sensed by flow meter 12 which adjusts shutoff valve 13 to permit the flow of the compressed gases through shutoff valve 13 at the desired pressure level.

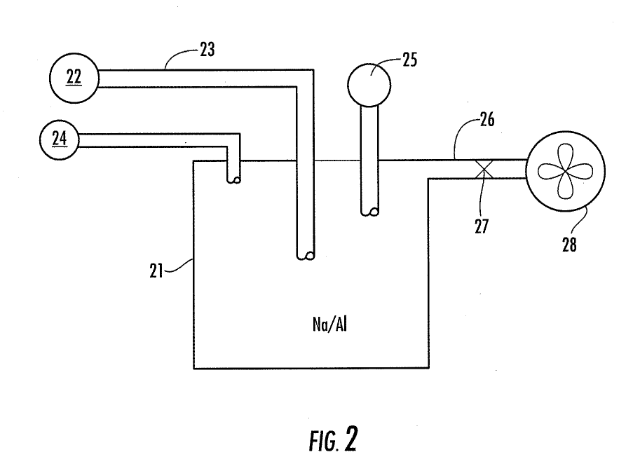

FIG. 2 shows another reaction chamber arrangement coupled with a single turbine. A reaction chamber 21 contains the sodium and aluminum reactants. A dosing pump 22 is connected into a water supply (not shown) and regulates the introduction of water into reaction chamber 21 through conduit 23. Reaction chamber 21 also contains an air outlet 24 and a pressure gauge 25. The hydrogen and steam generated exits reaction chamber 21 through conduit 26 at a pressure regulated by a valve 27. The gas under pressure is conveyed to a turbine 28 where the pressure is used as a driving force to generate energy. Because of expansion and transfer of energy from the pressurized gases to the turbine, some water may be condensed into liquid form. This water can be recovered and, if desired, recycled.

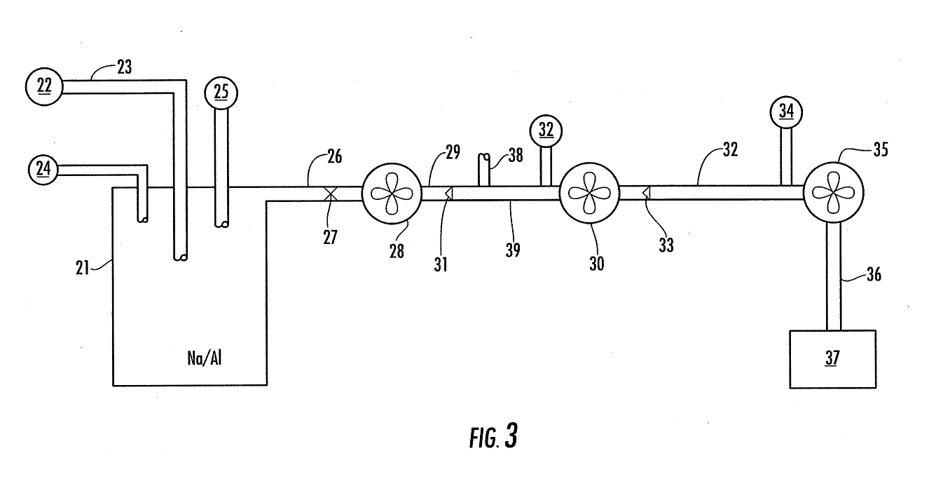

FIG. 3 shows a modification of the arrangement of FIG. 2 in which a series of turbines are used. The same arrangement of elements described in FIG. 2 are used here and the description will therefore not be repeated. After operating turbine 28, the gas is still under pressure and is conveyed through conduit 29 to a second turbine 30. Conduit 29 contains a one way valve 31 to prevent a backflow into turbine 28 and a pressure gauge 32 for monitoring the pressure of the gases flowing through conduit 29. After being utilized to operate turbine 30, the gas under pressure can be conveyed through conduit 32 containing one-way valve 33 and a pressure gauge 34 to a third turbine 35 where it is used to drive third turbine 35 and produce energy. Additional turbines can be provided until transmission losses cause the gas pressure to be inadequate to operate the next turbine in the sequence. After the last turbine in the sequence or, if desired at any point upstream of the last turbine, the hydrogen gas, or a portion of it, can be recovered and used as a fuel. For example, hydrogen recovered from third turbine 35 in FIG. 3 through conduit 36 can be conveyed to fuel cell 37 and employed therein as a fuel. Alternatively, the hydrogen can be supplied to a generator of an internal combustion engine what generates additional electricity. It will also be appreciated that any of the turbines can be replaced with a modified pneumatic cylinder described below, which are more efficient in generating power from pressure.

In one experiment it was found that a differential pressure necessary to run the turbines was 10 Kg/cm². If the pressure generated in the reactor was 100 Kg/cm² in the form of steam and hydrogen and the gas pressure was 90 Kg/cm² after the first turbine operation, the pressure reduction would be 10 Kg/cm² per cylinder, and it would theoretically have been possible to drive 10 turbines in the absence of transmission losses. Because of those transmission losses, it maybe possible to drive 7 or 8 of the turbines in sequence.

It has been experimentally determined that if the reactions involved in the system described above are appropriately handled, the systems can be safely and effectively employed. One of the main precautions to be taken is that an outlet valve should be open for air escape from the reactor before commencing the reactions in that reactor, if the reactor has not already been purged of oxygen. Failure to do so increases the risk of a violent reaction or explosion. The second most important precaution is to regulate the introduction of water into the sodium and aluminum in the reactor. Both steam and water react with the sodium so that when water introduction is stopped, the steam present will continue to react with these chemicals, increasing the pressure and temperature. It has been found that the use of pressure transducers and temperature controllers are not adequate and the safest operation is to adjust the water introduction based on a calculation of the pressure and heat necessary for the operation under consideration. For example, if it is determined that an operation needs about 20 Kg/cm² pressure and a 400° C. temperature employing a reactor which has been designed to resist 60 Kg/cm² pressure and a temperature of 800° C., using a dosing pump designed to shut off water introduction at 20 Kg/cm² provides a smooth and safe operation. The dosing pump is usually employed to pump less water into the reactor as the pressure in that reactor increases.

One advantage of using steam over water in the present invention is that the expansion of the water is 1600 fold and the hydrogen expansion is 36% for every 100° C. rise in temperature. As a result, the steam will be initially contributing more of the pressure power at the initial power generation point, e.g., at the first turbine, than later in a turbine sequence.

The gases which exit each turbine have lost a portion of their heat component. If desired, additional heat energy can be added to those gases. For example, as shown in FIG. 3, an air inlet 38 and an ignition device such as spark plug 39 can be provided in conduit 29 and/or other conduits in the sequence of turbines. By regulating the amount of air injected, a small quantity of the hydrogen present will become ignited, thereby building up the pressure to the desired level. Alternatively, sodium and aluminum can be placed in conduit 29 and/or 32 so that when relatively low pressure steam and hydrogen passes through the conduit, the steam reacts with the sodium and aluminum, increasing the steam energy and generating addition hydrogen to increase the pressure.

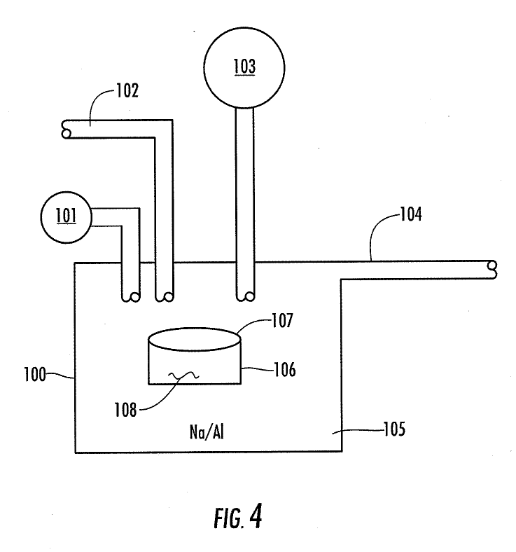

FIG. 4 is a schematic drawing of another embodiment of a reaction chamber according to the present invention. In this embodiment, a reactor 100 is provided and has a dosing pump 101, air vent 102, pressure gauge 103, and gas outlet 104 arranged in similar fashion to the reactor of FIG. 2. In the reactor of FIG. 4, the sodium and aluminum are disposed in the lower portion 105 of reaction chamber 100. Reactor 100 also has a secondary reaction chamber 106 disposed in its interior with an aperture 107 disposed above the level of reactants in lower portion 105 of reaction chamber 100 and the anticipated reaction products of the sodium, aluminum and water. Disposed in secondary reaction chamber 106 are appropriate chemicals 108 which cause the liberation of hydrogen at high temperatures and pressures. For example, those reactants can be sugar water and nickel which acts as a catalyst to generate additional hydrogen. Alternatively, metallic iron or metallic salts can be present, which, as is known, catalyze the production of hydrogen. Thus, for example, the water in the steam is under pressure and can penetrate into iron particles causing a production of hydrogen.

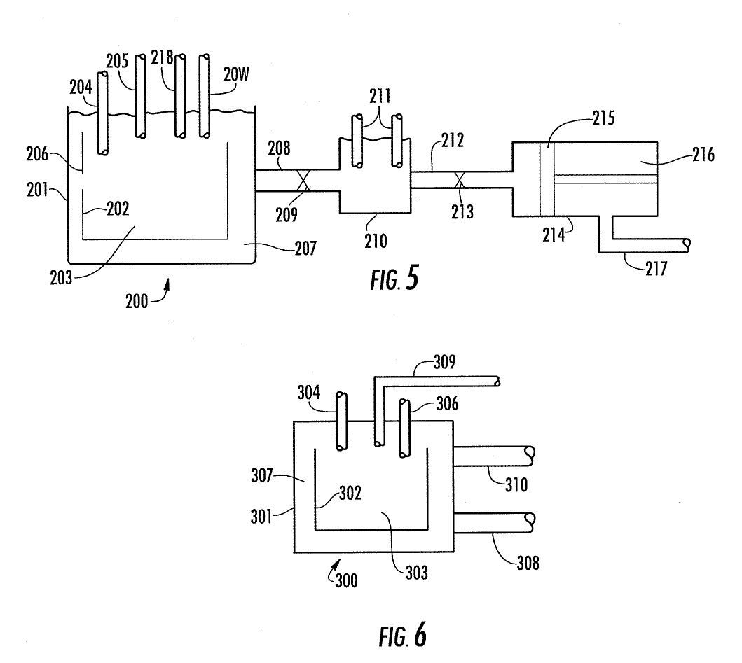

FIG. 5 illustrates a further reaction arrangement in accordance with the present invention. A reactor 200 is composed of an outer tank 201 and inner tank 202 whose walls are separated by a gap of, for example, 10-20 mm. Sodium and aluminum are positioned in a lower portion 203 of inner tank 202. Two water sprays 204 are provided for metering water into lower portion 203 containing the sodium and aluminum and an air outlet 205 is also provided. The sodium/water reaction and the sodium hydroxide/aluminum reaction generate heat which will cause the temperature to be over 200° C. and convert a part of the water into supersaturated steam. An aperture 206 is provided in the wall of inner tank 202 so that steam generated in inner tank 202 can enter into the gap 207 between outer tank 201 and inner tank 202. As the volume of steam and hydrogen increase as a result of the reactions taking place, the lighter hydrogen gas occupies the upper part of reactor 200 and the heavier steam occupies the lower portion 203 of inner tank 202 as well as the chamber defined by gap 207. As the reaction continues, the amount of heat increases and the hydrogen generated exerts a pressure on the steam generated, causing the steam in the lower portion of chamber 207 to become very dry and behave like a dry gas.

The hydrogen and steam gases are conveyed out of reactor 200 through conduit 208 which contains a shut-off valve 209 and enters pressure balancing tank 210 which is provided with a plurality of gas outlets 211 which can be operated to regulate the pressure of the gasses within tank 210. The use of tank 210 is optional. The pressurized gasses in tank 210 are conveyed through a conduit 212 which contains an adjustable shut-off valve 213 to a pneumatic cylinder 214. Cylinder 214 contains a piston 215 which is movable within cylinder 214 on shaft 216. The pressurized gasses cause piston 214 to move past outlet 217 which can be connected in series to one or more further cylinders. Movement of the piston is controlled by regulating the entry of the pressurized gasses by means of shut-off valve 213.

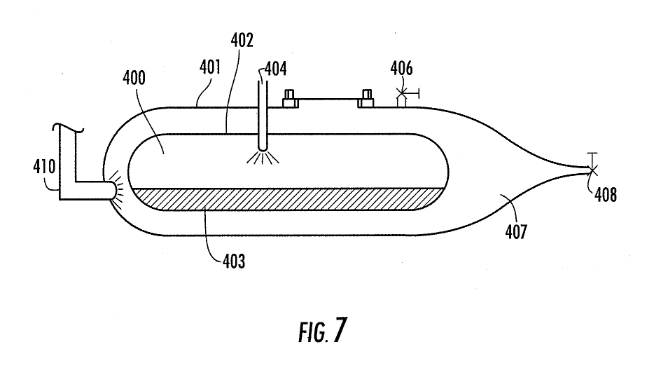

FIG. 6 shows an alternative arrangement to reactor 200 of FIG. 5. In FIG. 6, reactor 300 is composed of an outer tank 301 and an inner tank 302 with the sodium and aluminum occupying the lower portion 303 of inner tank 302. A water spray 304 and an air outlet 306 are provided, similarly to spray 204 and outlet 206 of FIG. 5. In FIG. 6, however, there is no aperture in the wall of inner tank 302 so that steam entry to the gap 307 between tanks 301 and 302 is by means of overflow over the top of the walls of inner chamber 302. In FIG. 6, an outlet conduit 308 is positioned in gap 307 to convey only steam out of reaction chamber 300 while a separate outlet conduit 309 is provided to remove hydrogen from an upper region of reactor 300. If desired, an auxiliary water inlet 310 can be provided leading into gap 307. In this arrangement, steam generated by the heat of reaction will be prevented from reaching the upper regions of reactor 300 because that region will be occupied by the hydrogen, the pressure of which will both cause the steam to dry and force it into gap 307. As a result, the water content of the steam in gap 307 will not be available to react with the sodium, allowing further control of the reaction. The configuration shown in FIG. 6 allows the hydrogen and the steam to be used separately or in combination to generate power by means of the pressure of the gasses, if desired.

FIG. 7 shows an alternative configuration to reactor 300 of FIG. 6. In FIG. 7, reactor 400 is composed of an outer tank 401 and an inner tank 402 with the sodium and aluminum occupying the lower portion 403 of inner tank 402. A water spray 404 and an air outlet 406 are provided, similarly to spray 304 and outlet 306 of FIG. 6. In FIG. 7, an outlet conduit 408 is positioned in gap 407 between tanks 401 and 402 to provide an outlet for hydrogen and steam from reaction chamber 400. Like in the arrangement in FIG. 6, here also, steam generated by the heat of reaction will be prevented from reaching the upper regions of reactor 400 because that region will be occupied by the hydrogen, the pressure of which will both cause the steam to dry and force it into gap 407. As a result, the water content of the steam in gap 407 will not be available to react with the sodium, allowing further control of the reaction. The configuration shown in FIG. 7 allows the hydrogen and the steam in combination to be used to generate power by means of the pressure of the gasses. If more thrust like that in jets is required, the hydrogen portion of the gasses at outlet 408 can be ignited to derive additional power. Also, if desired, an auxiliary water inlet 410 can be provided leading into gap 407.

Various changes and modifications can be made in the process and apparatus as described above without departing from the spirit and scope of the invention. The various embodiments disclosed herein were intended for illustration purposes only and not to limit the invention.

What is claimed is:

1. A method comprising
a. initiating a reaction between water and sodium in a reaction chamber to produce hydrogen, sodium hydroxide and heat;
b. utilizing the heat generated by said reaction to form steam and liquid sodium;
c. utilizing the steam and liquid sodium to react in said chamber to produce additional hydrogen, sodium hydroxide and heat;
d. reacting the sodium hydroxide with aluminum in the reaction chamber to form hydrogen and sodium aluminate; and
e. recovering said hydrogen.

2. The method of claim 1 wherein the hydrogen is recovered under pressure and then utilized as pressure source in a power generating device which uses the force of pressure.

3. The method of claim 2 wherein the hydrogen is recovered in combination with steam and then utilized as pressure source in a power generating device which uses the force of pressure.

4. The method of claim 2 further comprising recovery of sodium aluminate.

5. The method of claim 3 wherein said initial reaction is initiated by metering water into the reaction chamber containing the sodium at a rate insufficient to result in a rupture in the reaction chamber.

6. The method of claim 4 wherein a portion of said heat is recovered.

7. The method of claim 5 wherein the hydrogen recovered under pressure is utilized as pressure source in a plurality of power generating devices which use the force of pressure.

8. The method of claim 6 wherein the plurality of power generating devices are connected in series and after being utilized in one device, the pressurized hydrogen is conveyed to the next device in said series.

9. The method of claim 7 wherein the pressurized hydrogen being conveyed to a power generating device has its pressure increased by igniting a portion of the hydrogen.

10. The method of claim 2 wherein a portion of said heat is recovered.

11. The method of claim 2 wherein the hydrogen recovered under pressure is utilized as pressure source in a plurality of power generating devices which use the force of pressure.

12. The method of claim 10 wherein the plurality of power generating devices are connected in series and after being utilized in one device, the pressurized hydrogen is conveyed to the next device in said series.

13. The method of claim 1 wherein the hydrogen is recovered under pressure is utilized as pressure source in a plurality of power generating devices which uses the force of pressure.

14. The method of claim 1 wherein sufficient hydrogen is maintained in the reaction chamber so as to exert pressure on the steam and cause the steam to become a supersaturated dry gas.

15. An apparatus which comprises a reaction chamber which comprises a main chamber, a first water reservoir disposed outside the main chamber and in communication with the main chamber through a first closable water inlet, a main chamber closable air outlet, and a main chamber closable gas outlet.

16. The apparatus of claim 15 wherein the reaction chamber comprises a first chamber within which the main chamber is disposed and which is in open communication with the main chamber.

17. The apparatus of claim 16 further comprising a second closable water inlet disposed in a wall of the first chamber.

18. The apparatus of claim 17 wherein the main chamber is disposed within a second chamber which is disposed within the main chamber, the first chamber is in open communication with the second chamber and the second chamber is in open communication with the main chamber.

19. The apparatus of claim 18 wherein the first, second and main chambers are disposed coaxially.

20. The apparatus of claim 19 wherein the main chamber gas outlet communicates with an apparatus which utilizes pressure to generate power.

21. The apparatus of claim 15 wherein the main chamber gas outlet communicates with an apparatus which utilizes pressure to generate power.

22. The apparatus of claim 15 wherein main chamber closable gas outlet is disposed to provide an outlet for a plurality of gases.

23. The apparatus of claim 15 having an igniter for hydrogen disposed at about the main chamber closable gas outlet.
